(19) United States
(12) Patent Application Publication
(10) Pub. No.: US 2008/0101907 A1
(43) Pub. Date: May 1, 2008

(54) PALLET PROTECTION DEVICE WITH ENHANCED PALLET LIFTING APPRARATUS OPERATOR VISIBLITY

(75) Inventors: Kristen Karl Hedstrom, Orlando, FL (US); Matthew Carlisle Phelps, Orlando, FL (US); Terry Chalon Hutson, Peoria, AZ (US)

Correspondence Address: MICHAEL W. TAYLOR, P.O. BOX 3791, ORLANDO, FL, 32802-3791, US

(73) Assignee: CHEP International, Inc, Oriando, FL (US)

(21) Appl. No.: 11/553,275

(22) Filed: Oct. 26, 2006

(51) Int. Cl. B66F 9/18

(52) U.S. Cl. 414/607

(57) ABSTRACT

A device for improving a forklift operator's field of view may include a frame sized for attachment between forks of a forklift lift-carriage and the frame having a first end, a second end, and a middle portion narrower than the first end and the second end The device may further include an opening within the frame to improve the forklift operator's field of view with the opening defined by the first end, the second end, and the middle portion The device may yet further include a pallet-stop carried by the frame having a top, a bottom, and a side that reduces in dimension between the bottom of the pallet-stop to the top of the pallet-stop. The side may align with the opening to improve the forklift operator's field of view.

### FIELD OF THE INVENTION

The invention relates to the field of pallet lifting apparatuses, and, more particularly, to devices for pallet lifting apparatuses.

### BACKGROUND OF THE INVENTION

The palletization of goods has enabled efficiencies in the supply chain resulting in lower costs for products due to lower shipping cost. In a palletized supply chain, additional efficiencies may be realized by limiting damage to pallets produced by impacts with pallet lifting apparatuses such as forklifts, hand pallet trucks, order pickers, turret trucks, and the like.

For example, U.S. Pat. No. 2,956,701 to Larson, the entire contents of which is incorporated herein by reference, discloses a stringer impact device that attaches to the lift-carriage of a pallet lifting apparatus. The device includes a pair of laterally spaced pallet-stops which are disposed outside the forks of the pallet lifting apparatus The pallet-stops are either joined by a connecting member spanning the lift-carriage and forks or are directly fastened to a portion of the lift-carriage.

U.S. Pat. No. 4,102,464 to Schuster, the entire contents of which is incorporated herein by reference, discloses a pallet saving device that attaches between the forks of a pallet lifting apparatus. The device includes a pallet-stop connected at one end and a joiner for securing the pallet saving device to the lift-carriage of the pallet lifting apparatus.

Unfortunately, the above devices may not fully address the pallet protection problem. For instance, both devices limit portions of the pallet lifting apparatus operator's view of the pallet as the pallet lifting apparatus engages the pallet thereby requiring the pallet lifting apparatus operator to react to feel input rather than sight input. In addition, the problem of damage caused by the device itself to goods on the pallet is not addressed.

### SUMMARY OF THE INVENTION

In view of the foregoing background, it is therefore an object to provide a device that helps to protect a pallet and goods carried by the pallet while providing an enhanced field of view for the pallet lifting apparatus operator.

This and other objects, features, and advantages in accordance with the various embodiments are provided by a device for improving a pallet lifting apparatus operator's field of view that may include a frame sized for attachment between forks of a pallet lifting apparatus, and an opening within the frame for improving the pallet lifting apparatus operator's field of view. The device may further include a pallet-stop carried by the frame and positioned opposite the pallet lifting apparatus. The pallet-stop aids in limiting damage to a pallet.

For example, the pallet-stop may comprise an impact absorbent material. The pallet-stop may also comprise eased edges which help to reduce the chances the pallet-stop will engage the packaging of goods on the pallet In addition, the pallet-stop may be replaceable.

The frame may carry a joiner for connecting the frame to the pallet lifting apparatus. The frame may also carry a positioner opposite the joiner for connecting the frame to the pallet lifting apparatus.

The frame may comprise a first end, a second end, and a middle portion narrower than the first end and the second end. The opening may be defined by the first end, the second end, and the middle portion The frame may carry a pallet-stop on the second end. The frame may carry a joiner on the first end for connecting the frame to the pallet lifting apparatus. The frame may carry a positioner opposite the joiner for connecting the frame to the pallet lifting apparatus.

In an alternate embodiment, the frame may comprise a first end and a second end connected by a side-part. The opening may be defined by the first end, the second end, and the side-part.

In another embodiment, the device for improving a pallet lifting apparatus operator's field of view may comprise a pallet-stop having a top, a bottom, and a side, and the pallet-stop may be carried between forks of a pallet lifting apparatus. The side may reduce in dimension between the bottom of the pallet-stop and the top of the pallet-stop. As a result, the top of the pallet-stop may have less surface area to improve the pallet lifting apparatus operator's field of view. The device may further comprise a second side opposite the side, and the second side may also reduce in dimension between the bottom of the pallet-stop and the top of the pallet-stop.

In yet another embodiment, the device for improving a pallet lifting apparatus operator's field of view may comprise a frame sized for attachment between the forks of a pallet lifting apparatus, and an opening within the frame. The device may further comprise a pallet-stop carried by the frame with the pallet-stop having a top, a bottom, and a side that reduces in dimension between the bottom of the pallet-stop and the top of the pallet-stop. The top of the pallet-stop may be aligned with the opening in such a way as to improve the pallet lifting apparatus operator's field of view.

### BRIEF DESCRIPTION OF THE DRAWINGS

FIG. 1 is a front perspective view of a device for improving a pallet lifting apparatus operator's field of view when carried by a pallet lifting apparatus.

FIG. 2 is a side-angle perspective view of the device illustrated in FIG. 1.

FIG. 3 is a front perspective view of the device illustrated in FIG. 1.

FIG. 4 is a side perspective view of the device illustrated in FIG. 1.

FIG. 5 is a front perspective view of an alternative embodiment of the device illustrated in FIG. 1.

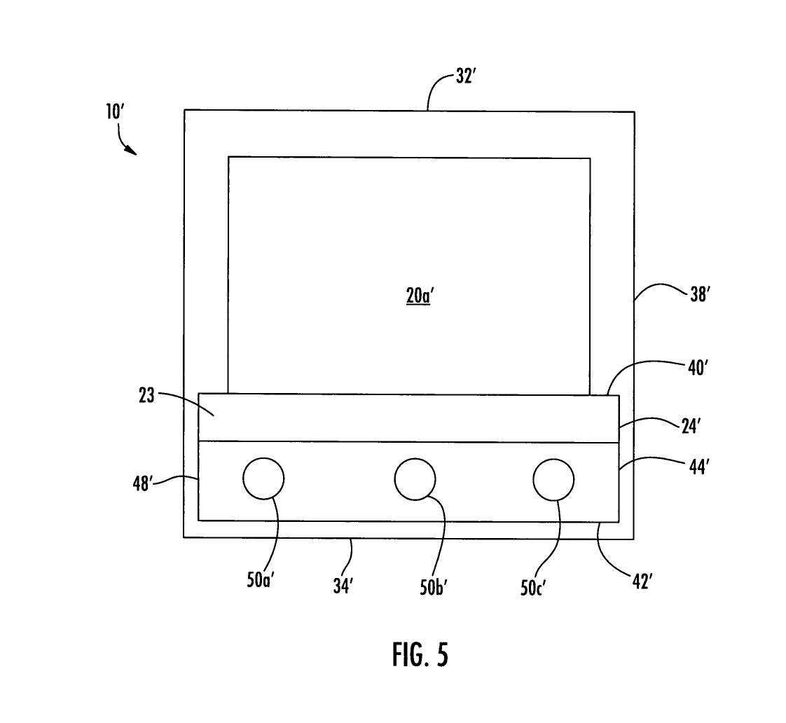

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

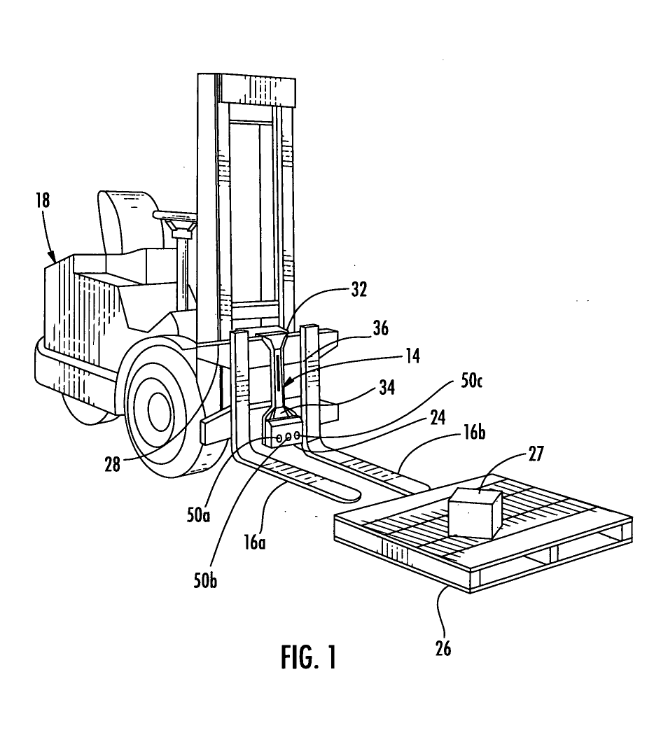

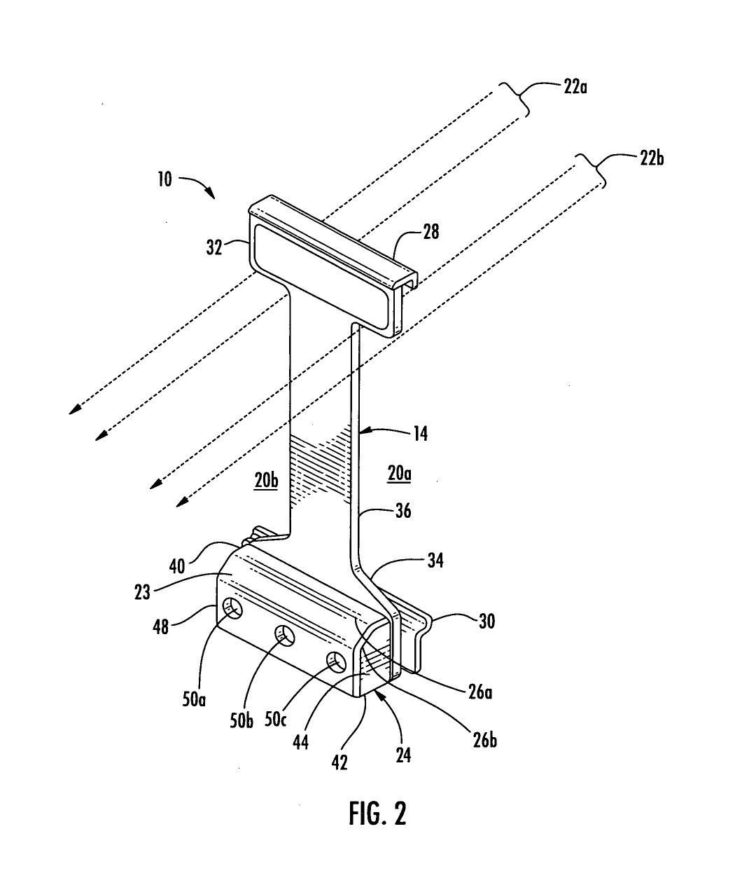

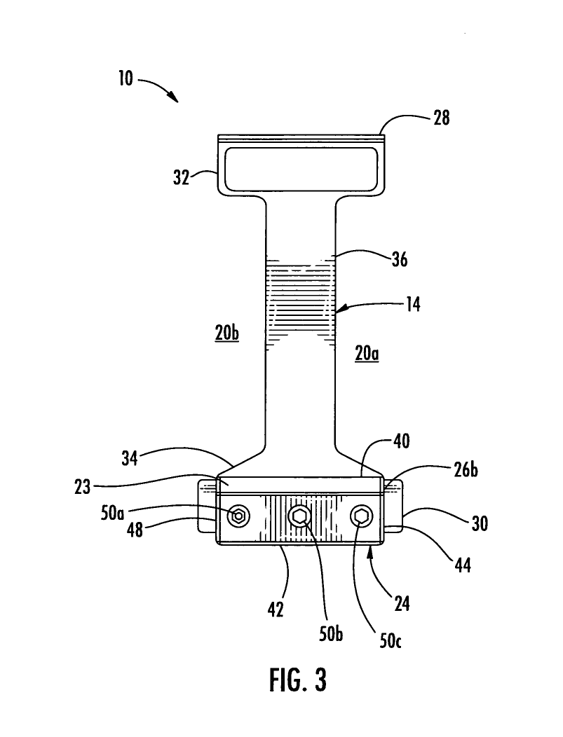

Referring initially to FIGS. 1-4, a device 10 for improving a pallet lifting apparatus operator's field of view 22a, 22b is now described. The device 10 includes a frame 14 sized for attachment between forks 16a, 16b of a pallet lifting apparatus 18, for example. The pallet lifting apparatus 18 is illustratedly shown in FIG. 1 as a forklift, but the pallet lifting apparatus may also be a hand pallet truck, an order picker, a turret truck, or the like.

There is at least one opening 20a, 20b within the frame 14 for improving a pallet lifting apparatus operator's field of view 22a, 22b. Stated another way, without the openings 20a, 20b, the pallet lifting apparatus operator's field of view 22a, 22b would be reduced.

The device 10 may further include a pallet-stop 24 carried by the frame 14 and positioned opposite the pallet lifting apparatus 18, for instance. The pallet-stop 24 aids in limiting damage to a pallet 26.

For example, the pallet-stop 24 comprises an impact absorbent material such as rubber, plastic, foam, or the like. The pallet-stop 24 may also comprise eased edges 26a, 26b which help to reduce the chances the pallet-stop will engage the packaging of a good 27 carried by the pallet 26. In other words, the eased edges 26a, 26b do not readily provide a surface that can easily become entangled with nearby packaging. In addition, the pallet-stop 24 may be replaceable. For instance, the pallet-stop 24 is secured to the frame 14 by removable mechanical fasteners 50a-50c. As will be appreciated by those of skill in the art, the pallet-stop 24 may be secured to the frame 14 by other fastening systems such as hook and loop fasteners, cinch straps, or the like.

The frame 14 carries a joiner 28 for connecting the frame to the pallet lifting apparatus 18 as will be understood by those of skill in the art. The frame 14 may also carry a positioner 30 opposite the joiner 28 for connecting the frame to the pallet lifting apparatus 18 For instance, the joiner 28 and the positioner 30 work together to secured frame 14 to the pallet lifting apparatus 18.

In one embodiment, the frame 14 comprises a first end 32, a second end 34, and a middle portion 36 narrower than the first end and the second end. The opening 20a, 20b is defined by the first end 32, the second end 34, and the middle portion 36, for example. In this embodiment, the frame 14 carries the pallet-stop 24 on the second end 34. Additionally, the frame 14 carries the joiner 28 on the first end 32 and a positioner 30 opposite the joiner 28 used for connecting the frame to the pallet lifting apparatus 18.

With additional reference to FIG, 5, an alternate embodiment of the device 10′ is illustrated. In this embodiment, the frame 14′ comprises a first end 32′ and a second end 34′ connected by a side-part 38′. The opening 20a′ is defined by the first end 32′, the second end 34′, and the side-part 38′, for instance.

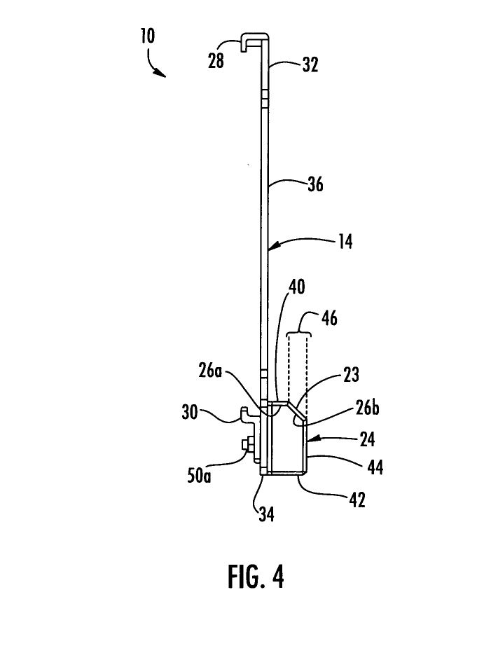

In another embodiment, the device 10 for improving a pallet lifting apparatus operator's field of view 22a, 22b comprises a pallet-stop 24 having a top 40, a bottom 42, and a side 44, and the pallet-stop being carried between the forks 16a, 16b of a pallet lifting apparatus 18. The side 44 reduces in dimension 46 (see FIG. 4) between the bottom 42 of the pallet-stop 24 and the top 40 of the pallet-stop. As a result, the top 40 of the pallet-stop 24 has less surface area 23 thereby improving the pallet lifting apparatus operator's field of view 22a, 22b. The device 10′ may further comprise a second side 48′ opposite the side 44′, and the second side may also reduce in dimension between the bottom 42′ of the pallet-stop 24′ and the top 40′ of the pallet-stop.

In yet another embodiment, the device 10 for improving a pallet lifting apparatus operator's field of view 22a, 22b comprises a frame 14 for attachment between the forks 16a, 16b of a pallet lifting apparatus 18, and at least one opening 20a, 20b within the frame. The device 10 further comprises a pallet-stop 24 carried by the frame 14 with the pallet-stop having a top 40, a bottom 42, and a side 44 that reduces in dimension 46 between the bottom of the pallet-stop and the top of the pallet-stop. The top 40 of the pallet-stop 24 may be aligned with the opening 20a, 20b in such a way as to improve the pallet lifting apparatus operator's field of view 22a, 22b.

Many modifications and other embodiments of the invention will come to the mind of one skilled in the art having the benefit of the teachings presented in the foregoing descriptions and the associated drawings Therefore, it is understood that the invention is not to be limited to the specific embodiments disclosed, and that other modifications and embodiments are intended to be included within the scope of the appended claims.

That which is claimed is:

1. A device for improving a pallet lifting apparatus operator's field of view, the device comprising:
a frame sized for attachment between forks of a pallet lifting apparatus, said frame having a first end, a second end, and a middle portion narrower than the first end and the second end; and
an opening within said frame for improving the pallet lifting apparatus operator's field of view, said opening defined by the first end, the second end, and the middle portion.

2. The device of claim 1 wherein said frame carries a pallet-stop positioned opposite the pallet lifting apparatus.

3. The device of claim 2 wherein said pallet-stop comprises an impact absorbent material.

4. The device of claim 2 wherein said pallet-stop comprises eased edges to limit said pallet-stop from catching on packaging.

5. The device of claim 2 wherein said pallet-stop is replaceable.

6. The device of claim 1 wherein said frame carries a joiner for connecting said frame to the pallet lifting apparatus.

7. The device of claim 6 wherein said frame carries a positioner opposite the joiner for connecting said frame to the pallet lifting apparatus.

8. The device of claim 2 wherein said frame carries the pallet-stop on the second end.

9. A device for improving a pallet lifting apparatus operator's field of view, the device comprising:
a pallet-stop having a top, a bottom, and a side, said pallet-stop carried between forks of a pallet lifting apparatus;
the side reducing in dimension between the bottom of said pallet-stop and the top of said pallet-stop, the top of the side having less surface area than the bottom of the side to thereby improve the pallet lifting apparatus operator's field of view.

10. The device of claim 9 wherein said pallet-stop further comprises a second side opposite the side, the second side reducing in dimension between the bottom of said pallet-stop and the top of said pallet-stop.

11. The device of claim 9 wherein said pallet-stop comprises an impact absorbent material.

12. The device of claim 9 wherein said pallet-stop comprises eased edges to limit said pallet-stop from catching on packaging.

13. A device for improving a pallet lifting apparatus operator's field of view, the device comprising:
a frame sized for attachment between the forks of a pallet lifting apparatus, said frame having a first end, a second end, and a middle portion, with the first end and the second end being wider than the middle portion;
an opening within said frame defined by the first end, the second end, and the middle portion; and
a pallet-stop carried by said frame, said pallet-stop having a top, a bottom, and a side that reduces in dimension between the bottom of said pallet-stop and the top of said pallet-stop, the top of said pallet-stop aligned with said opening thereby improving the pallet lifting apparatus operator's field of view.

14. The device of claim 13 wherein said pallet-stop further comprises a second side opposite the side, the second side reducing in dimension between the bottom of said pallet-stop and the top of said pallet-stop.

15. The device of claim 13 wherein said pallet-stop comprises an impact absorbent material.

16. The device of claim 13 wherein said pallet-stop comprises eased edges to limit said pallet-stop from catching on packaging.
